(19) United States
(12) Patent Application Publication
(10) Pub. No.: US 2016/0109996 A1
(43) Pub. Date: Apr. 21, 2016

(54) LIQUID CRYSTAL DISPLAY PANEL AND LIQUID CRYSTAL DISPLAY APPARATUS WITH INTEGRATED TOUCH SCREEN

(71) Applicant: SHENZHEN CHINA STAR OPTOELECTRONICS TECHNOLOGY CO., LTD., Shenzhen, Guangdong (CN)

(72) Inventor: Chengliang Ye, Shenzhen (CN)

(21) Appl. No.: 14/404,726

(22) PCT Filed: Nov. 6, 2014
(86) PCT No.: PCT/CN2014/090419

§ 371 Date: Dec. 1, 2014

(30) Foreign Application Priority Data
Oct. 17, 2014 (CN) 201410553394.3

(51) Int. Cl. G06F 3/041; G02F 1/1343; G02F 1/1335; G02F 1/133; G02F 1/1333; G02F 1/1368

(52) U.S. Cl. CPC G06F 3/0412; G02F 1/13338; G02F 1/1368; G02F 1/133514; G02F 1/13306; G02F 1/134309; G06F 2203/04103

(57) ABSTRACT

A liquid crystal display panel is provided, which includes an array substrate, a color filter substrate, a display driving chip, a touch driving chip and liquid crystal layer. The array substrate includes a data wire, a pixel electrode and common electrodes. The common electrodes include a touch driving common electrode and a touch sensing common electrode. The touch driving common electrode is connected with a common voltage source via a first switch. The touch sensing common electrode is connected with the common voltage source via a second switch. The technical feature ensures the displaying effect of the display panel.

### FIELD OF THE INVENTION

The present invention relates to a field of displays, and in particular to a liquid crystal display panel and a liquid crystal display apparatus with an integrated touch screen.

### BACKGROUND OF THE INVENTION

With the development of technology, touch screens are becoming increasingly popular. A touch display screen may include a touch sensor panel and a display panel which is superposed with the former. After the arrangement of the display panel is complete, a part of a touch-sensitive elements of the touch sensor panel are disposed in at least a part of a visible area of the display panel.

This display panel can accomplish various display functions. The touch sensor panel can recognize the touch operation on the touch display screen. The touch sensor panel includes driving wires and sensing wires, the manufacturing material of which is generally a transparent conductive material, such as indium tin oxide (ITO), etc. The touch sensor panel can be superposed on the display panel to form the touch display screen.

Therefore, the developer of the touch display screen divides the common electrodes of the display panel into multiple sections which are electrically insulated from each other. Each section of the common electrodes has the function of the driving wires and the sensing wires of the touch sensor panel. In order to allow the display panel to sense touches and display images simultaneously, paths with a high electrical resistivity are used for connecting the common electrodes with ground or a common voltage, so that the common electrodes, which function as the driving wires and the sensing wires, generate touch signals during scanning the touch signals. The sensing function is accomplished, in addition, the voltage of the touch signals is continuously released through the paths with high electrical resistivity, and the displaying function is achieved.

However, the paths with high electrical resistivity can only release limited electric charge. If the electricity accumulated on the common electrodes is too great, residual electric charge may be caused on the common electrodes, interfering with the displaying effect of the liquid crystal display panel.

Therefore, it is required to provide a liquid crystal display panel and a liquid crystal display apparatus with an integrated touch screen for solving the problem of the prior art.

### SUMMARY OF THE INVENTION

A primary object of the present invention is to provide a liquid crystal display panel and a liquid crystal display apparatus with an integrated touch screen for releasing residual electric charge on common electrodes effectively and ensuring the displaying effect of the display panel, in order to resolve the technical problem of the current liquid crystal display panel and the liquid crystal display apparatus with the integrated touch screen, which has excessive residual electric charge on the common electrodes, thus interfering with the displaying effect of the liquid crystal display panel.

To achieve the above object, the present invention provides a technical solution as follows:

An embodiment of the present invention provides a liquid crystal display panel with an integrated touch screen, comprising an array substrate, a color filter substrate, a display driving chip, a touch driving chip, and a liquid crystal layer disposed between the array substrate and the color filter substrate, wherein the array substrate comprises:

a data wire for transmitting a data signal;

a pixel electrode for driving liquid crystal molecules in the crystal layer based on the data signal, and

common electrodes for providing common signals;

wherein the common electrodes comprise a touch driving common electrode and a touch sensing common electrode which are mutually insulated and used for detecting a touch operation, the touch driving common electrode and the touch sensing common electrode are respectively connected with the touch driving chip, the touch driving common electrode is connected with a common voltage source via a first switch, the touch sensing common electrode is connected with the common voltage source via a second switch,

after the liquid crystal display panel detects a touch signal, the first switch and the second switch are switched to a turned-on state, and after a preset period, the first switch and the second switch are then switched to a turned-off state,

wherein the preset period is determined based on frame detection time of touch signal detection, and the common source voltage source is a zero voltage source or a ground source.

In the liquid crystal display panel with the integrated touch screen of the present invention, an input terminal of the first switch is connected with the touch driving common electrode, an output terminal of the first switch is connected with the common voltage source, and a control terminal of the first switch is connected with a touch signal source,

an input terminal of the second switch is connected with the touch sensing common electrode, an output terminal of the second switch is connected with the common voltage source, and a control terminal of the second switch is connected with the touch signal source.

In the liquid crystal display panel with the integrated touch screen of the present invention, when the touch signal source is outputting at a high level, the first switch and the second switch are in the turned-on state, and when the touch signal source is outputting at a low level, the first switch and the second switch are in the turned-off state.

In the liquid crystal display panel with the integrated touch screen of the present invention, the preset period is 5 microseconds to 10 microseconds.

An embodiment of the present invention provides a liquid crystal display panel with an integrated touch screen, comprising an array substrate, a color filter substrate, a display driving chip, a touch driving chip, and a liquid crystal layer disposed between the array substrate and the color filter substrate, wherein the array substrate comprises:

a data wire for transmitting a data signal;

a pixel electrode for driving liquid crystal molecules in the crystal layer based on the data signal, and

common electrodes for providing common signals;

wherein the common electrodes comprise a touch driving common electrode and a touch sensing common electrode which are mutually insulated and used for detecting a touch operation, the touch driving common electrode and the touch sensing common electrode are respectively connected with the touch driving chip, the touch driving common electrode is connected with a common voltage source via a first switch, the touch sensing common electrode is connected with the common voltage source via a second switch,

after the liquid crystal display panel detects a touch signal, the first switch and the second switch are switched to a turned-on state, and after a preset period, the first switch and the second switch are then switched to a turned-off state.

In the liquid crystal display panel with the integrated touch screen of the present invention, an input terminal of the first switch is connected with the touch driving common electrode, an output terminal of the first switch is connected with the common voltage source, and a control terminal of the first switch is connected with a touch signal source,

an input terminal of the second switch is connected with the touch sensing common electrode, an output terminal of the second switch is connected with the common voltage source, and a control terminal of the second switch is connected with the touch signal source.

In the liquid crystal display panel with the integrated touch screen of the present invention, when the touch signal source is outputting at a high level, the first switch and the second switch are in the turned-on state, and when the touch signal source is outputting at a low level, the first switch and the second switch are in the turned-off state.

In the liquid crystal display panel with the integrated touch screen of the present invention, the preset period is determined based on frame detection time of touch signal detection.

In the liquid crystal display panel with the integrated touch screen of the present invention, the preset period is 5 microseconds to 10 microseconds.

In the liquid crystal display panel with the integrated touch screen of the present invention, the common source voltage source is a zero voltage source.

In the liquid crystal display panel with the integrated touch screen of the present invention, the common source voltage source is a ground source.

An embodiment of the present invention also provides a liquid crystal display apparatus with an integrated touch screen, comprising a backlight source and a liquid crystal display panel, the liquid crystal display panel comprising an array substrate, a color filter substrate, a display driving chip, a touch driving chip, and a liquid crystal layer disposed between the array substrate and the color filter substrate, wherein the array substrate comprises:

a data wire for transmitting a data signal;

a pixel electrode for driving liquid crystal molecules in the crystal layer based on the data signal, and

common electrodes for providing common signals;

wherein the common electrodes comprise a touch driving common electrode and a touch sensing common electrode which are mutually insulated and used for detecting a touch operation, the touch driving common electrode and the touch sensing common electrode are respectively connected with the touch driving chip, the touch driving common electrode is connected with a common voltage source via a first switch, the touch sensing common electrode is connected with the common voltage source via a second switch,

after the liquid crystal display panel detects a touch signal, the first switch and the second switch are switched to a turned-on state, and after a preset period, the first switch and the second switch are then switched to a turned-off state.

In the liquid crystal display apparatus with the integrated touch screen of the present invention, an input terminal of the first switch is connected with the touch driving common electrode, an output terminal of the first switch is connected with the common voltage source, and a control terminal of the first switch is connected with a touch signal source,

an input terminal of the second switch is connected with the touch sensing common electrode, an output terminal of the second switch is connected with the common voltage source, and a control terminal of the second switch is connected with the touch signal source.

In the liquid crystal display apparatus with the integrated touch screen of the present invention, when the touch signal source is outputting at a high level, the first switch and the second switch are in the turned-on state, and when the touch signal source is outputting at a low level, the first switch and the second switch are in the turned-off state.

In the liquid crystal display apparatus with the integrated touch screen of the present invention, the preset period is determined based on frame detection time of touch signal detection.

In the liquid crystal display apparatus with the integrated touch screen of the present invention, the preset period is 5 microseconds to 10 microseconds.

In the liquid crystal display apparatus with the integrated touch screen of the present invention, the common source voltage source is a zero voltage source.

In the liquid crystal display apparatus with the integrated touch screen of the present invention, the common source voltage source is a ground source.

Compared with the liquid crystal display panel and the liquid crystal display apparatus in the prior art, the liquid crystal display panel and the liquid crystal display apparatus with the integrated touch screen in the present invention instantly release residual electric charge on the common electrodes via the first switches and the second switches, prevent the electric charge from remaining on the common electrodes, resolving the technical problem of the current liquid crystal display panel and the liquid crystal display apparatus with the integrated touch screen, which has excessive residual electric charge on the common electrodes, thus interfering with the displaying effect of the liquid crystal display panel.

To make the foregoing contents of the present invention more clearly understood, the preferred embodiments are described in detail below in conjunction with accompanying drawings.

### BRIEF DESCRIPTION OF THE DRAWINGS

FIG. 1 is a structural schematic diagram of a liquid crystal display panel with an integrated touch screen in accordance with a preferable embodiment of the present invention.

FIG. 2 is an equivalent circuit diagram common electrodes of a liquid crystal display panel with an integrated touch screen in accordance with a preferable embodiment of the present invention.

### DETAILED DESCRIPTION OF THE PREFERRED EMBODIMENTS

The following description of the embodiments with reference to the accompanying drawings is used to illustrate particular embodiments of the present invention. The directional terms referred in the present invention, such as “upper”, “lower”, “front”, “after”, “left”, “right”, “inner”, “outer”, “side surface”, etc. are only directions with regard to the accompanying drawings. Therefore, the directional terms used for describing and illustrating the present invention are not intended to limit the present invention.

In the drawings, units with similar structures are indicated by the same reference number.

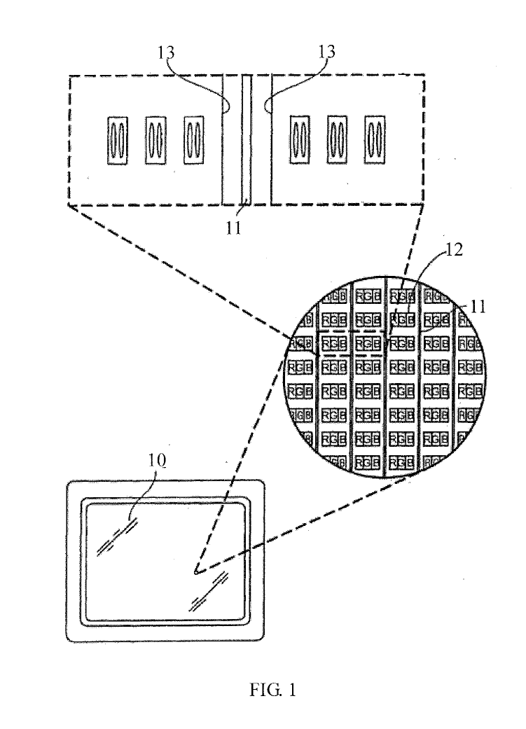

A liquid crystal display panel with an integrated touch screen of the present invention can be a mobile terminal of a mobile phone, etc. Please refer to FIG. 1., which is a structural schematic diagram of a liquid crystal display panel with an integrated touch screen in accordance with a preferable embodiment of the present invention. The liquid crystal display panel 10 includes an array substrate, a color filter substrate, a display driving chip, a touch driving chip, and a liquid crystal layer. The specific structures and the usages of the color filter substrate, the display driving chip, the touch driving chip and the liquid crystal layer are the same as the specific structures and the usages of the color filter substrate, the display driving chip, the touch driving chip and the liquid crystal layer in the prior art are not shown in the FIGs., and are not described herein.

The array substrate includes data wires 11, pixel electrodes 12, and common electrodes 13. The data wires are used for transmitting data signals, the pixel electrodes are used for driving liquid crystal molecules in the crystal layer based on the data signals, and the common electrodes are used for providing common signals.

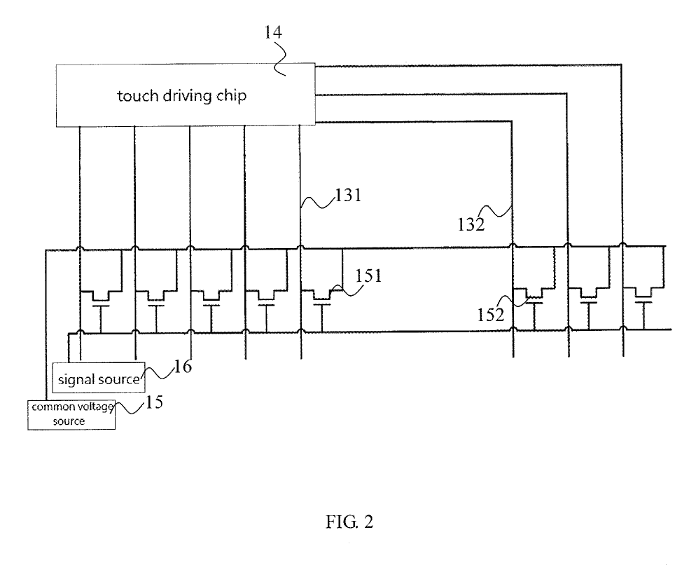

Please refer to FIG. 2., which is an equivalent circuit diagram of the common electrodes of a liquid crystal display panel with an integrated touch screen in accordance with a preferable embodiment of the present invention. Since the common electrodes 13 of the array substrate are present in each pixel of the array substrate, the common electrodes 13 in the liquid crystal display panel 10 can be used as touch electrodes and sensing electrodes for detecting a touch operation. Therefore, the common electrodes 13 include touch driving common electrodes 131 and touch sensing common electrodes 132 which are mutually insulated and used for detecting a touch operation, and the touch driving common electrodes 131 and the touch sensing common electrodes 132 are respectively connected with the touch driving chip 14. Hence, the touch driving chip 14 can detect touch signals via the touch driving common electrodes 131 and the touch sensing common electrodes 132. Meanwhile, the touch driving common electrodes 131 are connected with a common voltage source 15 via first switches 151, the touch sensing common electrodes 132 are connected with the common voltage source 15 via second switches 152.

Specifically, the input terminals of the first switches 151 are connected with the touch driving common electrodes 131, the output terminals of the first switches 151 are connected with the common voltage source 15, and the control terminals of the first switches 151 are connected with a touch signal source 16, the input terminals of the second switches 152 are connected with the touch sensing common electrodes 132, the output terminals of the second switches 152 are connected with the common voltage source 15, and the control terminals of the second switches 152 are connected with the touch signal source 16. When the touch signal source 16 is outputting at a high level, the first switches 151 and the second switches 152 are in the turned-on state, and when the touch signal source 16 is outputting at a low level, the first switches 151 and the second switches 152 are in the turned-off state. The common source voltage source 15 is a zero voltage source or a ground source.

In use of the liquid crystal display panel 10 of the preferred embodiment, the touch signal source 16 generally outputs at the low level, that is to say, the first switches 151 and the second switches 152 are generally in the turned-off state, so that the electric charge on the common electrodes 13 of the liquid crystal display panel 10 can be released slowly via leaking currents on the first switches 151 and the second switches 152, meeting the requirement of the image display of the liquid crystal display panel 10. Furthermore, if the liquid crystal display panel 10 is detecting the touch signals or scanning the touch signals, the electric charge of the touch signals can quickly accumulate on the common electrodes 13 (the touch driving common electrodes 131 and the touch sensing common electrodes 132), allowing the touch driving chip 14 to be able to quickly detect the touch signals.

After the liquid crystal display panel 10 conducts the touch signal detection, or after a frame detection of the touch signal detection, much electric charge of the touch signals has accumulated on the common electrodes 13, and then the touch signal source 16 outputs at a high level, that is to say, the first switches 151 and the second switches 152 are switched to the turned-on state, and the accumulated charge on the common electrodes 13 is quickly released to the common voltage source 15 via the first switches 151 and the second switches 152, so that the accumulated charge on the common electrodes 13 does not interfere with the image display of the liquid crystal display panel 10. Furthermore, since no touch signal detection or touch signal scanning is conducted at this time, the release of the electric charge will not interfere with the detection results of the touch signals.

After a preset period, the touch signal source 16 outputs at the low level, that is, the first switches and the second switches are then switched to the turned-off state for waiting for the next touch signal detection or the touch signal scanning. The preset period is determined based on the frame detection time of the touch signal detection. If the frame detection time of the touch signal detection is longer, that is, more electric charge accumulates on the common electrodes 13, a longer preset period can be set, in order to achieve the purpose of a complete release of the electric charge. If the frame detection time of the touch signal detection is shorter, that is, less electric charge accumulates on the common electrodes 13, the shorter preset period can be set. The preset period is preferably from 5 microseconds to 10 microseconds. Then after the liquid crystal display panel 10 conducts the touch signal detection, the first switches 151 and the second switches 152 cyclically conduct the disconnecting or conducting operation (i.e., the high level or low level switching operation of the touch signal source 16).

In order to effectively release the electric charge accumulated on the common charge electrodes 13 to the common voltage source 15, the common voltage source 15 is preferably a zero voltage source or a ground source.

This way completes the process of the image display and the touch operation of the liquid crystal display panel with the integrated touch screen 10 in the preferred embodiment of the present invention.

When displaying an image, the liquid crystal display panel with the integrated touch screen in the present invention instantly releases the residual electric charge on the common electrodes via the first switches and the second switches, prevents the electric charge from remaining on the common electrodes, and ensures the displaying quality of the liquid crystal display panel. When the liquid crystal display panel with the integrated touch screen in the preferable embodiment is detecting the touch signals, the touch driving chip detects the touch signals via the first switches and the second switches in a turned-off state for ensuring the detection efficiency of the touch operation of the liquid crystal display panel.

The present invention also provides a liquid crystal display apparatus with an integrated touch screen, comprising a backlight source and a liquid crystal display panel. The liquid crystal display panel comprises an array substrate, a color filter substrate, a display driving chip, a touch driving chip, and a liquid crystal layer disposed between the array substrate and the color filter substrate.

The array substrate comprises data wires, pixel electrodes, and common electrodes. The data wires are used for transmitting data signals, the pixel electrodes are used for driving liquid crystal molecules in the crystal layer based on the data signals, and the common electrodes are used for providing common signals.

The common electrodes comprise touch driving common electrodes and touch sensing common electrodes which are mutually insulated and used for detecting touch operation. The touch driving common electrodes and the touch sensing common electrodes are respectively connected with the touch driving chip. The touch driving common electrodes are connected with a common voltage source via first switches, and the touch sensing common electrodes are connected with the common voltage source via second switches.

The input terminals of the first switches are connected with the touch driving common electrodes, the output terminals of the first switches are connected with the common voltage source, and the control terminals of the first switches are connected with a touch signal source, the input terminals of the second switches are connected with the touch sensing common electrodes, the output terminals of the second switches are connected with the common voltage source, and the control terminals of the second switch are connected with the touch signal source. When the touch signal source is outputting at a high level, the first switch and the second switch are in the turned-on state, and when the touch signal source is outputting at a low level, the first switch and the second switch are in the turned-off state. The common voltage source is preferably a zero voltage source or a ground source.

After the liquid crystal display panel detects touch signals, the first switches and the second switches are switched to a turned-on state, and after a preset period, the first switches and the second switches are then switched to a turned-off state. The preset period is determined based on frame detection time of touch signal detection. The preset period is 5 microseconds to 10 microseconds.

The operating principle of the liquid crystal display apparatus with the integrated touch screen of the present invention is the same as or similar to the relative description of the preferred embodiment of the above liquid crystal display panel with the integrated touch screen. For the details, please refer to the related description of the above liquid crystal display panel with the integrated touch screen of the preferred embodiment.

The liquid crystal display panel and the liquid crystal display apparatus with the integrated touch screen of the present invention instantly release residual electric charge on common electrodes via the first switches and the second switches, prevent the electric charge from remaining on the common electrodes, resolve the technical problem of the current liquid crystal display panel and the liquid crystal display apparatus with the integrated touch screen, which have excessive residual electric charge on the common electrodes, thus interfering with the displaying effect of the liquid crystal display panel.

In summary, although the preferred embodiment of the present invention has been disclosed above, the foregoing preferred embodiment of the present invention is not intended to limit the present invention. A person of ordinary skill in the art, without departing from the spirit and the scope of the invention, may make various modifications and variations. Therefore, the scope of the present invention is defined in the claims.

What is claimed is:

1. A liquid crystal display panel with an integrated touch screen, comprising an array substrate, a color filter substrate, a display driving chip, a touch driving chip, and a liquid crystal layer disposed between the array substrate and the color filter substrate, wherein the array substrate comprises:
a data wire for transmitting a data signal;
a pixel electrode for driving liquid crystal molecules in the crystal layer based on the data signal; and
common electrodes for providing common signals;
wherein the common electrodes comprise a touch driving common electrode and a touch sensing common electrode which are mutually insulated and used for detecting touch operation, the touch driving common electrode and the touch sensing common electrode are respectively connected with the touch driving chip, the touch driving common electrode is connected with a common voltage source via a first switch, the touch sensing common electrode is connected with the common voltage source via a second switch,
after the liquid crystal display panel detects a touch signal, the first switch and the second switch are switched to a turned-on state, and after a preset period, the first switch and the second switch are then switched to a turned-off state,
wherein the preset period is determined based on frame detection time of touch signal detection, and the common source voltage source is a zero voltage source or a ground source.

2. The liquid crystal display panel with the integrated touch screen as claimed in claim 1, wherein an input terminal of the first switch is connected with the touch driving common electrode, an output terminal of the first switch is connected with the common voltage source, and a control terminal of the first switch is connected with a touch signal source,
an input terminal of the second switch is connected with the touch sensing common electrode, an output terminal of the second switch is connected with the common voltage source, and a control terminal of the second switch is connected with the touch signal source.

3. The liquid crystal display panel with the integrated touch screen as claimed in claim 2, wherein when the touch signal source is outputting at a high level, the first switch and the second switch are in the turned-on state, and when the touch signal source is outputting at a low level, the first switch and the second switch are in the turned-off state.

4. The liquid crystal display panel with the integrated touch screen as claimed in claim 1, wherein the preset period is 5 microseconds to 10 microseconds.

5. A liquid crystal display panel with an integrated touch screen, comprising an array substrate, a color filter substrate, a display driving chip, a touch driving chip, and a liquid crystal layer disposed between the array substrate and the color filter substrate, wherein the array substrate comprises:
a data wire for transmitting a data signal;
a pixel electrode for driving liquid crystal molecules in the crystal layer based on the data signal, and
common electrodes for providing common signals;
wherein the common electrodes comprise a touch driving common electrode and a touch sensing common electrode which are mutually insulated and used for detecting touch operation, the touch driving common electrode and the touch sensing common electrode are respectively connected with the touch driving chip, the touch driving common electrode is connected with a common voltage source via a first switch, the touch sensing common electrode is connected with the common voltage source via a second switch,
after the liquid crystal display panel detects a touch signal, the first switch and the second switch are switched to a turned-on state, and after a preset period, the first switch and the second switch are then switched to a turned-off state.

6. The liquid crystal display panel with the integrated touch screen as claimed in claim 5, wherein an input terminal of the first switch is connected with the touch driving common electrode, an output terminal of the first switch is connected with the common voltage source, and a control terminal of the first switch is connected with a touch signal source,
an input terminal of the second switch is connected with the touch sensing common electrode, an output terminal of the second switch is connected with the common voltage source, and a control terminal of the second switch is connected with the touch signal source.

7. The liquid crystal display panel with the integrated touch screen as claimed in claim 6, wherein when the touch signal source is outputting at a high level, the first switch and the second switch are in the turned-on state, and when the touch signal source is outputting at a low level, the first switch and the second switch are in the turned-off state.

8. The liquid crystal display panel with the integrated touch screen as claimed in claim 6, wherein the preset period is determined based on frame detection time of touch signal detection.

9. The liquid crystal display panel with the integrated touch screen as claimed in claim 8, wherein the preset period is 5 microseconds to 10 microseconds.

10. The liquid crystal display panel with the integrated touch screen as claimed in claim 5, wherein the common source voltage source is a zero voltage source.

11. The liquid crystal display panel with the integrated touch screen as claimed in claim 5, wherein the common source voltage source is a ground source.

12. A liquid crystal display apparatus with an integrated touch screen, comprising a backlight source and a liquid crystal display panel, the liquid crystal display panel comprising an array substrate, a color filter substrate, a display driving chip, a touch driving chip, and a liquid crystal layer disposed between the array substrate and the color filter substrate, wherein the array substrate comprises:
a data wire for transmitting a data signal;
a pixel electrode for driving liquid crystal molecules in the crystal layer based on the data signal, and
common electrodes for providing common signals;
wherein the common electrodes comprise a touch driving common electrode and a touch sensing common electrode which are mutually insulated and used for detecting touch operation, the touch driving common electrode and the touch sensing common electrode are respectively connected with the touch driving chip, the touch driving common electrode is connected with a common voltage source via a first switch, the touch sensing common electrode is connected with the common voltage source via a second switch,
after the liquid crystal display panel detects a touch signal, the first switch and the second switch are switched to a turned-on state, and after a preset period, the first switch and the second switch are then switched to a turned-off state.

13. The liquid crystal display apparatus with the integrated touch screen as claimed in claim 12, wherein an input terminal of the first switch is connected with the touch driving common electrode, an output terminal of the first switch is connected with the common voltage source, and a control terminal of the first switch is connected with a touch signal source,
an input terminal of the second switch is connected with the touch sensing common electrode, an output terminal of the second switch is connected with the common voltage source, and a control terminal of the second switch is connected with the touch signal source.

14. The liquid crystal display apparatus with the integrated touch screen as claimed in claim 13, wherein when the touch signal source is outputting at a high level, the first switch and the second switch are in the turned-on state, and when the touch signal source is outputting at a low level, the first switch and the second switch are in the turned-off state.

15. The liquid crystal display apparatus with the integrated touch screen as claimed in claim 12, wherein the preset period is determined based on frame detection time of touch signal detection.

16. The liquid crystal display apparatus with the integrated touch screen as claimed in claim 15, wherein the preset period is 5 microseconds to 10 microseconds.

17. The liquid crystal display apparatus with the integrated touch screen as claimed in claim 12, wherein the common source voltage source is a zero voltage source.

18. The liquid crystal display apparatus with the integrated touch screen as claimed in claim 12, wherein the common source voltage source is a ground source.
